(19) United States
(12) Patent Application Publication
(10) Pub. No.: US 2020/0239207 A1
(43) Pub. Date: Jul. 30, 2020

(54) STORAGE SYSTEM WITH REMOTE MONITORING AND MANAGEMENT CAPABILITIES

(71) Applicant: ERIA SMART TECHNOLOGIES, INC., Ottawa (CA)

(72) Inventors: Simon Bontempo, Grimsby (CA); Pierre Cléroux, Ottawa (CA); Alexandre D'Aoust, Ottawa (CA); Michael William Dunleavy, Ottawa (CA); Andrew Goodwin, Russell (CA); Miles Hammond, Ottawa (CA)

(21) Appl. No.: 16/702,934

(22) Filed: Dec. 4, 2019

Related U.S. Application Data
(60) Provisional application No. 62/797,620, filed on Jan. 28, 2019.

(51) Int. Cl. B65D 55/02; G08C 17/02; G08B 29/02; G08B 13/22; G08B 21/18; G07C 9/00; E05G 1/10; E05B 39/00; E05B 41/00; E05B 65/52

(52) U.S. Cl. CPC B65D 55/02; G08C 17/02; G08B 29/02; G08B 13/22; G08B 21/182; E05G 1/06; E05G 1/10; E05B 39/005; E05B 41/00; E05B 65/52; G07C 9/00309

(57) ABSTRACT

The present invention provides a storage system that is capable of actively monitoring the state of the product being stored and providing remote notifications to the user regarding the state of the stored product.

### FIELD OF THE INVENTION

The present invention pertains to the field of storage systems and in particular to storage systems having remote monitoring and management capabilities.

### BACKGROUND

Storage systems that are tailored to the storage requirements of the contents being stored are known in the art. For example, jewelry may be kept in a box provided with a locking mechanism to prevent unauthorized access, and tobacco products may be stored in a humidor to control humidity loss that can negatively impact the quality of the tobacco.

It has long been recognized as beneficial to store cannabis products in an airtight container to maintain the product in its optimum state. One of the most popular airtight storage methods is storage in a Mason jar. Unfortunately, this storage method is not secure against unauthorized access by children. This storage method also does not safeguard against exposure to UV light, and so requires the additional step of storing the jar in a dark place, away from exposure to UV light, to maintain the quality of the product. The clear glass of the jar also allows the contents to be visible, which can lead to security concerns.

The impact of storage conditions on the quality of the cannabis product was confirmed by the study “The Stability of Cannabis and its Preparations on Storage,” conducted by J. W. Fairbairn, J. A. Liebmann, and M. G. Rowan from the Pharmacology Department in the School of Pharmacy, University of London in 1975, in which cannabis and resin was stored under varying conditions for two years and changes in THC potency were observed. It was found that that the best long-term weed storage method required keeping cannabis at room temperature in a dark and sealed container.

It has also been recognized that management of the humidity levels for cannabis storage is essential for maintaining the cannabis product in its optimum state.

Both cannabinoids and terpenes are manufactured in small resin glands present on the flowers and main fan leaves of late-stage cannabis plants called trichomes. Studies have empirically shown that cannabis will retain a higher terpene and cannabinoid content when the cannabis is stored at the optimal humidity range of between 55% and 65% RH for a prolonged period of time. This translates to a more robust flavor and a great high.

There are many cannabis storage products available today that are capable of limiting exposure to light and maintaining constant humidity levels, and more continue to hit the market each year. However, these storage products are passive and require the user to personally check on the state of the stored product.

There is therefore a need for a secure storage system that is capable of actively monitoring the state of the product being stored and providing remote notifications to the user regarding the state of the stored product, while also providing security against access by children or pets, and unauthorized access.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a storage system with remote monitoring and management capabilities. In accordance with an aspect of the present invention, there is provided a system for secure storage and management of a stored product comprising a storage module comprising a body member having a bottom and side walls forming an interior volume; a cover member moveable between an open position and a closed position, the cover member being adapted for sealing engagement with the body member when in the closed position to provide a sealed interior volume; one or more compartments located within the interior volume of the body member, wherein at least one of the compartments is a storage compartment for storing the product; and a locking system for locking the cover member in the closed position. The product storage system also comprises a management module, the management module comprising: one or more sensors for obtaining information regarding one or more states of the system; a remote terminal configured to display the information regarding one or more states of the system; and a network interface component coupling the system to a wireless network configured to transmit the information to a receiver associated with the remote terminal, wherein the information is displayed on a user interface on the remote terminal.

### BRIEF DESCRIPTION OF THE FIGURES

FIG. 1 illustrates a top perspective view of a storage system in one embodiment of the present invention, with the cover in a closed position.

FIG. 2 illustrates a front view of a storage system in one embodiment of the present invention, with the cover in an open position.

FIG. 3 illustrates a side view of a storage system in one embodiment of the present invention, with the cover in an open position.

FIG. 4 illustrates a front view of a storage system in one embodiment of the present invention, with the cover in a closed position.

FIG. 5 illustrates a rear view of a storage system in one embodiment of the present invention, with the cover in a closed position.

FIG. 6 illustrates a bottom view of a storage system in one embodiment of the present invention, with the cover in a closed position.

FIG. 7 illustrates a top perspective view of a body member of a storage system in one embodiment of the present invention.

FIGS. 8A-C are top perspective views of tray inserts for use in a storage system in one embodiment of the present invention.

FIG. 9 is a cross-sectional view of the storage system in one embodiment of the present invention, with the cover in a closed/locked position, viewed along plane A-A.

FIG. 10 is a cross-sectional view of the storage system in one embodiment of the present invention, with the cover in a open/unlocked position, viewed along plane B-B.

FIG. 11 is a portion of the cross-sectional view of the storage system in one embodiment of the present invention with the cover in a closed/locked position, viewed along plane C-C.

FIG. 12 is the expanded view of section E from FIG. 11.

FIGS. 13A-D are views of a lock plate of a cover member for use in a storage system in one embodiment of the present invention.

FIG. 14 is a mobile application user interface in accordance with one embodiment of the present invention.

### DETAILED DESCRIPTION OF THE INVENTION

### Definitions

The term “cannabis product” is defined as any product derived from the Cannabis plant, including fresh or dried cannabis plant material (e.g., cannabis bud, seeds), cannabis oils, resins, chemically concentrated extracts (e.g., hash oil/shatter/budder/wax), products containing cannabis derivatives such as tinctures, sprays, creams, salves, and liniments, as well as cannabis edibles and other ingestible products containing cannabis derived ingredients.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a secure and sealed storage system for storing products that keeps the stored products out of the hands of children, animals, or access attempts by persons who have not been granted authorization. The storage system also provides an internal storage environment for maintaining the stored product in optimal condition for an extended period of time.

Although the system of the present invention is described as particularly suitable for the secure storage of cannabis products, it is recognized that the present system can be used to store any product of value that may be susceptible to adverse storage conditions and which could benefit from the remote monitoring capabilities provided by the present system. For example, the system can be used to store pharmaceutical products, supplements, tobacco products (such as loose tobacco, pipe tobacco or cigars), or jewelry.

In accordance with the present invention, there is provided a product storage system comprising a storage module for storing the product, and a management module for monitoring one or more states of the storage system.

In preferred embodiments, the storage module comprises a body member comprising one or more compartments located therein, a cover member adapted for sealing engagement with the body member to form a sealed interior volume in a closed position; and a locking system for locking the cover member in the closed position.

In preferred embodiments, the management module comprises sensors for obtaining information regarding one or more states of the system; and a remote terminal configured to display this information displayed on a user interface on the remote terminal.

The storage system of the present invention therefore allows the user to remotely monitor the storage system through a wireless network connection, and provides notifications to the user regarding the location and state of the storage system and the state of the stored product on the remote terminal.

In preferred embodiments, the remote terminal is configured to display the information obtained by the sensors regarding one or more states of the system. The information is transmitted to a receiver associated with the remote terminal via a network interface component coupling the system to a wireless network, wherein the network interface component of the present system may be an infrared apparatus, a Bluetooth apparatus, a WIFI apparatus and/or an Internet apparatus. As such, the remote terminal is an apparatus matching the wireless communication apparatus and is capable of infrared communication, Bluetooth communication, or accessing the network via WIFI or the Internet.

In accordance with the present invention, the remote terminal may be a smartphone, a tablet, a laptop, a personal computer, or a wall mounted device, all of which are configured to display the information on a user interface.

In a preferred embodiment, the management module may be remotely monitored via a mobile application associated with the remote terminal. In such an embodiment, information regarding one or more states of the storage system can be displayed on a user interface on the remote terminal, wherein the information can be monitored and displayed in real-time.

Information transmitted to the user regarding the one or more states of the storage system can include, but is not limited to, information regarding the relative humidity and/or temperature inside the storage compartment(s), the weight of the product inside the storage compartment(s), the location of the system, and/or whether the system is open or closed or locked or unlocked. The system can also be configured to monitor the number of times the storage container has been successfully and/or unsuccessfully accessed, or if the storage system has been moved.

The storage system can also be configured to provide alert notifications when one or more states of the storage system fall outside predetermined parameters, including, but not limited to, when the relative humidity and/or the temperature is too high or too low, or when the weight of the stored product falls below a predetermined value. The storage system can also be configured to provide an alert when the number of unsuccessful access attempts exceeds a predefined number.

The storage module is preferably formed of a body member having a bottom and side walls forming an interior volume, and a cover member adapted for sealing engagement with the body member to prevent the loss of moisture.

Located within the interior volume of the body member are one or more compartments. In one embodiment, at least one compartment is provided with features customized according to the product being stored. Additional compartments may optionally be provided to store tools or related paraphernalia associated with the stored product. For example, for pharmaceutical product storage systems, medications may be stored in separate compartments according to different types of medications or according to different dosage regimens, as well as tools for crushing or measuring doses of medication. For tobacco storage systems, different types of tobacco may be stored in different compartments, as well as tools such as lighters, rolling papers, cigar cutters, or pipe tampers. For jewelry storage systems, different items of jewelry may be stored in different compartments, along with polishing or cleaning products.

For embodiments of the storage system adapted to store cannabis products, at least one of the compartments is a storage compartment for storing a cannabis product. In one embodiment, multiple cannabis product storage compartments are provided to ensure that different strains/products can be stored separately to avoid transfer of volatile aromatic compounds which can have a negative impact on flavour. The one or more compartments may also include compartments for holding paraphernalia associated with cannabis use, such as a rolling tray, rolling papers, lighters, and the like.

The management module is provided with one or more sensors for obtaining information regarding one or more states of the system.

In a preferred embodiment, the management module includes a humidity sensor associated with the storage compartment for measuring a relative humidity level in the storage compartment.

In a further embodiment, the management module may also include a weight sensor for measuring a weight of the product in the storage compartment, and/or a temperature sensor associated with the storage compartment for measuring a temperature in the storage compartment.

In a further embodiment, the management module may also include a biosensor for monitoring for the presence of biological contaminants such as mold.

In a preferred embodiment, the management module is configured to issue an alert if one or more monitored states of the storage system exceed a predetermined value. In such an embodiment, the management module further comprises a non-transitory memory; and one or more hardware processors coupled to the non-transitory memory and configured to read instructions from the non-transitory memory to cause the system to perform operations comprising obtaining the information regarding one or more states of the system and determining whether the obtained values regarding the one or more states of the system fall within a predetermined range of values. If the obtained values do not fall within the predetermined range of values, an alert is issued by the management module and displayed on the remote terminal user interface.

In one embodiment, the mobile application receives an alert from the management module with respect to changes in one or more states of the system and displays the alert on the user interface.

For example, an alert may be issued to notify the user if a humidity sensor detects that the humidity level in the storage compartment has fallen below a predetermined minimum value or exceeds a predetermined maximum value. In one embodiment, an alert is reported to and displayed on the user interface of the mobile application.

In response to an alert, command instructions can be entered via a user interface by the user using the mobile application to send instructions to the management module to vary one or more states of the storage system.

Accordingly, in a further embodiment, the management module may also be remotely controlled via a mobile application, and command instructions related to control of the management module can be entered by the user using the mobile application via the user interface on the remote terminal.

In one embodiment, the management module may be configured to monitor the amount of stored product remaining in a storage compartment, and once the amount falls below a threshold value, issue a notification alert to the remote terminal with an accompanying link to one or more online vendor services to facilitate ordering additional product(s). In one embodiment, a weight alert is reported to and displayed on the user interface of the mobile application. In one embodiment, the amount of product present in the storage compartment is monitored using a weighing mechanism such as a built-in scale.

In another embodiment, in response to an alert that the weight of the stored product falls below a predetermined value, command instructions can be entered by the user via a user interface on the mobile application to instruct the management module to order more product.

In another embodiment, in response to an alert that the weight of the stored product falls below a predetermined value, the management module, according to predefined user settings, automatically orders more product.

In another embodiment, the management module can be set to automatically order more product if the management module detects that certain state conditions are not met, according to predefined user settings.

In a further embodiment, the management module may also comprise a motion sensor (e.g., an accelerometer) to detect when the system is moved. For those embodiments in which the system includes a motion sensor, the management module can be configured to issue an alert to the remote terminal if the unit is moved. In one embodiment, a motion alert is reported to and displayed on the user interface of the mobile application.

In one embodiment, the storage system is provided with a location tracker, for example, a GPS tracker or a Bluetooth tracker and can report the storage system location to the mobile application.

The storage module, in a preferred embodiment, includes a locking system for locking the cover member in the closed position. In such an embodiment, the management module may also include a sensor associated with the locking system, wherein the locking system sensor notifies the user's remote terminal when the storage module is opened, measures the number of times the storage module is opened and/or the number of unsuccessful attempts to open the storage module. The management module can also be configured to issue a notification if the cover has been left in the open position for longer than a predetermined period of time. In one embodiment, notifications regarding system access are reported to and displayed on the user interface of the mobile application.

If the locking system sensor detects a number of unsuccessful attempts to open the storage module that exceeds a predetermined number, an alert is issued to notify the user. In one embodiment, a locking system alert is reported to and displayed on the user interface of the mobile application.

The locking system can comprise any configuration of locking element associated with the cover member that can cooperatively engage with a corresponding locking element associated with the body member to lock the cover member in the closed position.

In one embodiment, the locking system can be engaged and disengaged directly by the user, for example, by manual manipulation of the locking mechanism, through the use of a key-type access, or through the use of biometric verification.

In one embodiment, the locking system can be engaged (locked) or disengaged (unlocked) remotely using a command sent via a wireless network connection.

In one embodiment, the locking system can be engaged or disengaged remotely using command instructions entered by the user via a user interface on the mobile application.

The locking system can therefore be provided as a combination lock, a passcode activated lock, a voice activated lock, a biometric verification activated lock (employing, for example, fingerprint, voice, signature, retina or iris verification), a USB key activated lock, or any combination thereof.

In one embodiment, the locking system comprises a latching member movable from a locked position, in which the cover cannot be opened, to an unlocked position, in which the cover may be opened and the inside of the storage system can be accessed. The latching member may employ any suitable locking mechanism.

In one embodiment, the locking system employs a sliding locking mechanism, including but not limited to, a sliding hook and slot configuration, or a sliding pin and keyhole configuration. In embodiments employing such a sliding mechanism, the locking system may further comprise a rack-and-pinion type actuator powered by a motor that can be remotely controlled using a command sent via a wireless network connection.

In one embodiment, the locking system can be configured to automatically lock the storage module if certain conditions are not satisfied within a user defined period of time. For example, if the cover has not been opened within a defined period of time (e.g., 5 minutes) after being unlocked, the locking system will be automatically engaged. If the locking system is not re-engaged within a defined period of time (e.g., 5 minutes) after the cover has been closed, the locking system will be automatically engaged. The period of time in which the conditions must be satisfied to avoid engaging the automatic locking system can be adjusted by the user as required.

In one embodiment, the storage system employs an external indicator to provide an indication when the storage module is in a locked or unlocked state. For example, an external indicator is provided that would use different colors to indicate whether the storage module is locked (e.g., red) or unlocked (e.g., green). In a preferred embodiment, the external indicator is an LED light source.

In one embodiment, the locking system further comprises a magnetic component comprising at least one pair of magnets adjacent to each other, each pair being located on the cover member, and at least one corresponding magnet located on the body member.

In each pair of magnets on the cover member, the two magnets are arranged in opposite polarity relative to each other, i.e., the north pole of one magnet is adjacent the south pole of the other magnet. When the sliding locking mechanism is in the locked position, the corresponding magnet on the body member is located adjacent to an opposing magnet on the cover member whose magnet face has the opposite polarity, i.e., the two adjacent magnets are magnetically attracted to each other. When the sliding locking mechanism slides into the unlocked position, the corresponding magnet on the body member is located adjacent to an opposing magnet on the cover member that has the same polarity, i.e., the two opposing magnets magnetically repel each other, causing the cover member to pop open. In one embodiment, command instructions can be entered via a user interface by the user using the mobile application to send instructions to the locking system to engage or disengage the locking mechanism through movement of the magnets.

It is also within the scope of this invention that the pair of magnets with opposite polarity are located on the body member side, and the corresponding magnet is located on the cover member side.

In a preferred embodiment, the storage module is manufactured from an opaque material to ensure minimal exposure to UV light to avoid degradation of the product being stored. The storage module may be manufactured from materials including, but not limited to, molded plastic, rubber, steel, aluminum or any combination thereof.

Depending on the materials employed, the cover member may provide the sealing engagement with the body member through resilient fit. In those embodiments where the materials used to form the storage module do not allow for resilient fit, the system further comprises a sealing element between the cover member and the body member.

The system may be powered by any suitable power source. In one embodiment, the system employs an external power source. In one embodiment, the system employs a rechargeable power source. In one embodiment, the system employs an external power source and a backup battery power source in case of disconnection from the external power source. The system can therefore further be configured to issue an alert notification when the system is disconnected from an external power source, or for battery powered systems, when the remaining battery charge falls below a predetermined threshold value. In one embodiment, a power supply alert is reported to and displayed on the user interface of the mobile application.

In one embodiment, the remote terminal is configured to issue an alert when the system is disconnected from the wireless network. In one embodiment, a connectivity alert is reported to and displayed on the user interface of the mobile application.

All sensor and related monitoring aspects of the present storage system, including notifications, can be activated or deactivated according to the needs and desires of the user.

In one embodiment, the storage system also comprises a humidity management module to manage the humidity level in the storage system to minimize exposure to excess moisture which can lead to damage or degradation of the stored product.

In accordance with a preferred embodiment of the present invention, the storage system is a cannabis product storage system comprising a storage module for storing the cannabis product, and a management module for monitoring one or more states of the storage system. In some embodiments of the cannabis storage system, a humidity management module is provided to manage the humidity level to help mitigate evaporative loss from the trichomes by preventing drying out of the product, while also avoiding over-humidification of the product that can lead to mold growth. The humidity management module can also be used to rehumidify a cannabis product that has dried out.

For embodiments used for storage of moisture sensitive products, a storage compartment having relative humidity values in excess of about 65% can lead to mold growth. A storage compartment having relative humidity values below about 50% can lead to drying out of the stored product. Accordingly, in one embodiment, the humidity management module provides a means for maintaining the relative humidity at an optimum level for the storage of the stored products.

In a preferred embodiment, the storage system is for storage of cannabis products, and the humidity management module maintains the relative humidity value at from about 55% to about 62% relative humidity.

In one embodiment, the humidity management module comprises a dessicating agent such as silica gel, calcium oxide, clays, calcium salts such as CaSO₄, molecular sieves or the like.

In one embodiment, the humidity management module comprises a single-use, replaceable humectant/dessicant system. One example of a single-use product that can be used in the present humidity management module is a Boveda® humidifying packet, which employs a combination of water and salts to maintain a specified environmental relative humidity.

In one embodiment, the humidity management module comprises a reusable humectant/dessicant system. One example of a multiple use product that can be used in the present humidity management module is VaporBeads®, which employs amorphous silica beads impregnated with a salt-based solution, which acts as both a desiccant and a humidifier when introduced to water.

In one embodiment, the humidity management module continually responds to ambient conditions by adding or removing moisture to affect the environment in the storage compartment to deliver the desired, pre-determined relative humidity values.

In one embodiment, the humidity management module provides a means for increasing the relative humidity in the storage compartment, when the humidity level has dropped below the ideal relative humidity level for the storage of moisture sensitive products. In such an embodiment, the humidity management module can be used to rehumidify a product that has dried out.

In one embodiment, the storage module further comprises an external humidity display to display the relative humidity level in the storage compartment. In one embodiment, the humidity display is a digital display.

In one embodiment, the management module may be configured to monitor one or more states of the system over a period of time (e.g., variances in weight of the product in a storage compartment, frequency of storage module access, time(s) of day when the storage module is accessed) and provide the collected information to the user or to third parties interested in obtaining and aggregating information related to patterns of product consumption.

Although the above embodiments are configured to communicate information related to the states of the storage system to the remote terminal over a wireless network, it is recognized that the present system can also be configured for connection to the remote terminal via a networking device such as a router, or other wired connections such as a USB cable. The system can also be integrated with a smart speaker systems such as Amazon Echo, HomePod, Google Home, Sonos One, and the like, whereby audio commands are used to send instructions to the storage system.

It is also understood to be within the scope of the present invention to provide storage systems are scalable to provide systems that are large enough to be used to store commercial amounts of product, i.e., an amount that exceeds what would be typical for personal use. The present storage devices can also be scaled to provide storage systems suitable for shipping cannabis products. The invention will now be described with reference to a specific example. It will be understood that the following example is intended to describe one embodiment of the invention and are not intended to limit the invention in any way.

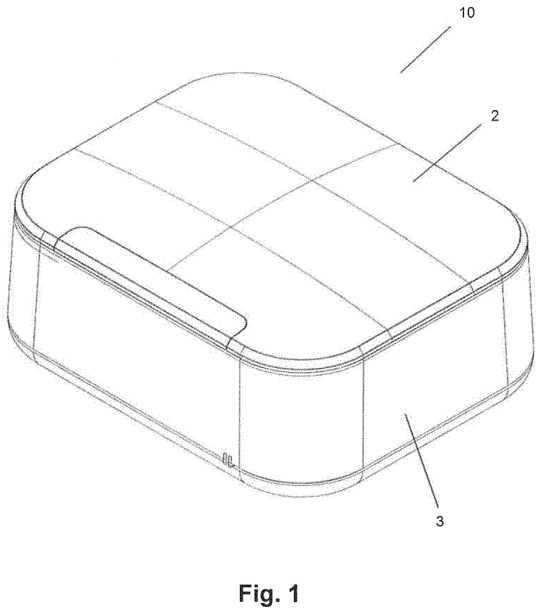

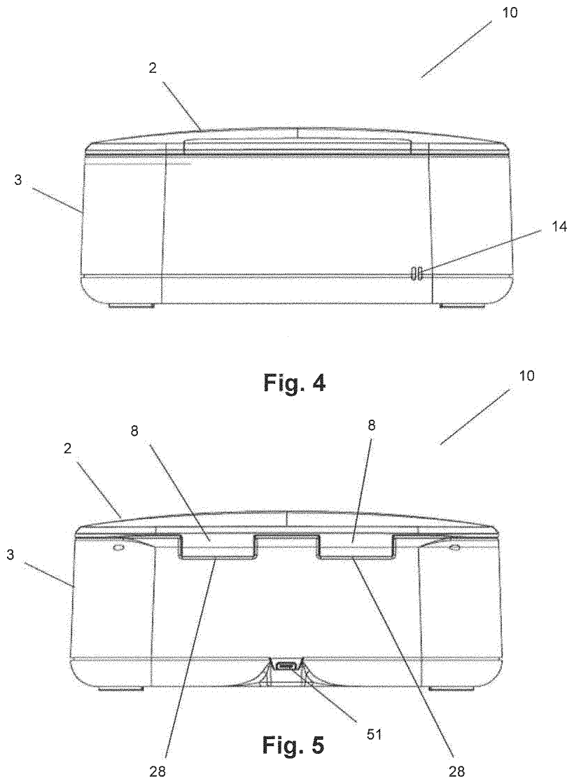

One exemplary embodiment of a storage system 10 in accordance with the present invention is depicted in FIGS. 1 to 6. FIGS. 1, 4 and 5 show storage system 10 is shown with cover member 2 in a closed configuration. Body member 3 is shown with indicator lights 14 (FIGS. 4 and 5), which can be configured to provide an indication of the state of the storage system. Cover 2 is hingedly attached to body member 3 by hinge arms 8 located in hinge slots 28. Also shown is charging port 51.

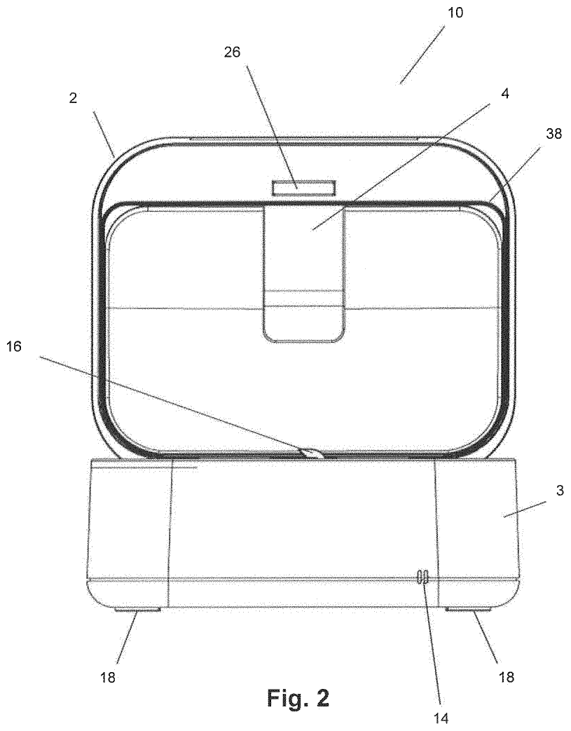

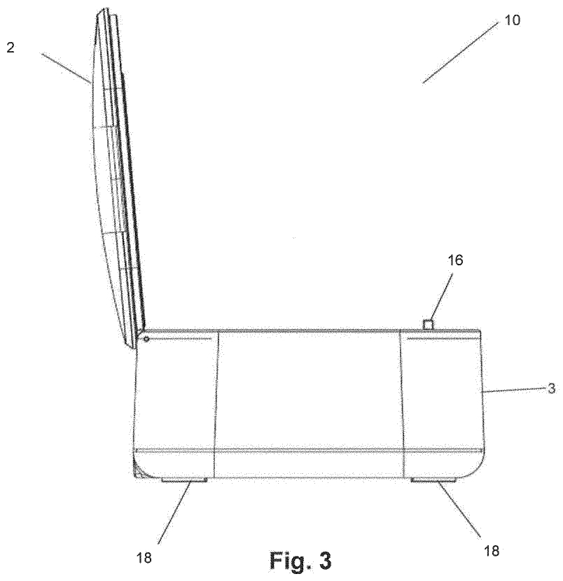

FIGS. 2 and 3 depict storage system 10 with cover member 2 in an open position. Elements of the locking system, including latch 16, associated with body member 3, and corresponding slot 26 in cover member 2, are also shown, as well as humidity management module holder 4, which is provided to hold a humidity management module in place.

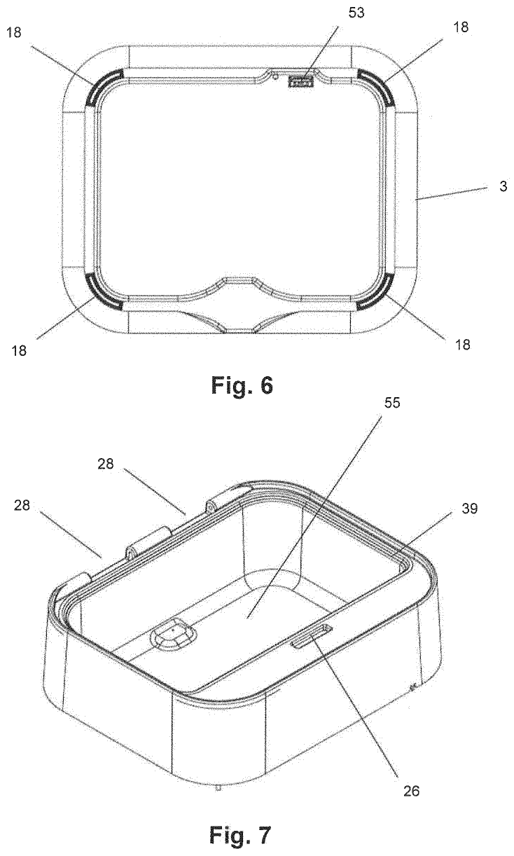

FIG. 6 is a bottom view of system 10, depicting support feet 18 located at the bottom face of each corner of body 3, and USB port 53.

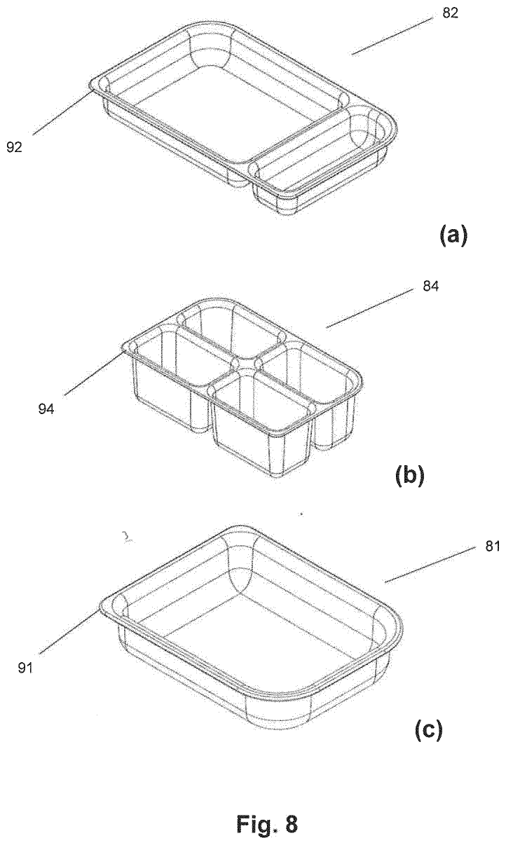

FIG. 7 depicts an exemplary body member 3 without a cover member in place, showing interior chamber 55, configured to receive one or more compartment trays for holding the stored product and associated paraphernalia. FIGS. 8A-C depict exemplary compartment trays adapted to fit within interior chamber 55, including two compartment tray 82, four compartment tray 84 and one compartment tray 81, each of which have a respective peripheral flange 92, 94, 91 adapted to rest on support ledge 39 located around the upper periphery of interior chamber 55.

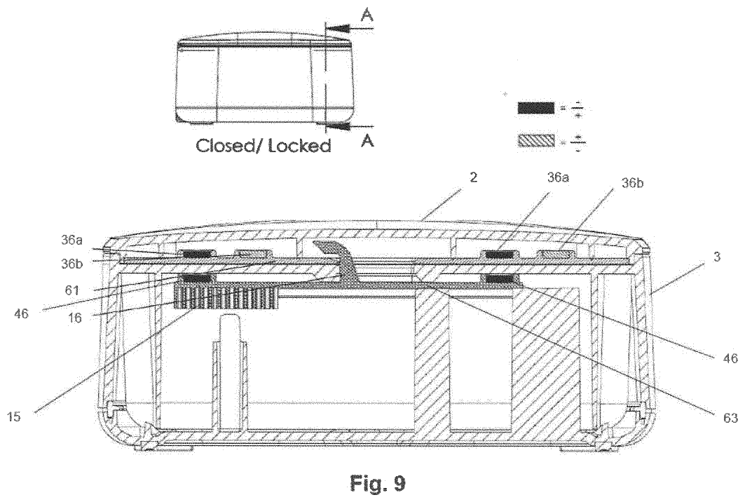

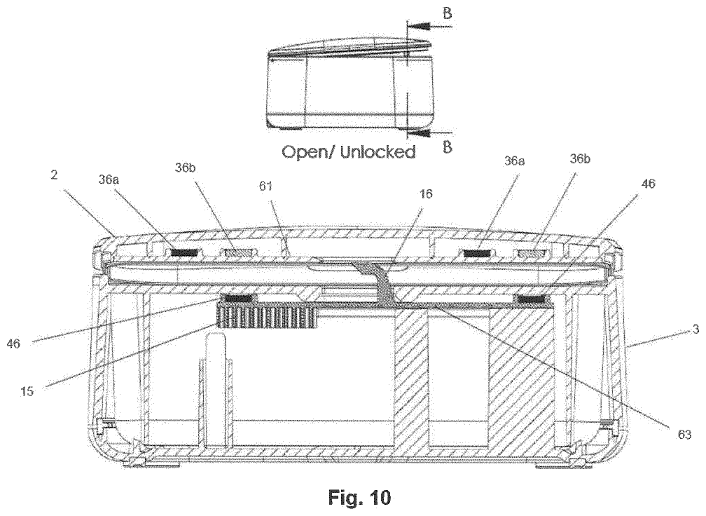

FIGS. 9 to 12 depict components of a locking system used in accordance with one embodiment of the storage system of the present invention. In the embodiment depicted in these figures, cover member 2 includes fixed lock plate 61 having two pairs of magnets 36a and 36b, located in magnet wells 76a and 76b respectively, each magnet of a respective pair being arranged in opposite polarity relative to each other. Bottom member 3 comprises sliding lock carriage 63 having carriage magnets 46 located in carriage wells 73, lock carriage 63 being movable between a locked position (FIG. 9) and an unlocked position (FIG. 10). When sliding lock carriage 63 is in the locked position, as shown in FIG. 9, carriage magnet 46 is located adjacent to an opposing magnet 36a on cover member 2 whose magnet face has the opposite polarity, leading to magnetic attraction between the two magnets. When sliding lock carriage 63 is in the locked position, latch 16 is located within slot 26, preventing cover 2 from being opened.

When sliding lock carriage 63 slides into the unlocked position, as shown in FIG. 10, carriage magnet 46 is located adjacent to an opposing magnet 36b having the same polarity, leading to the magnetic repellence between the two adjacent magnets, causing the cover member to pop open. When sliding lock carriage 63 is in the unlocked position, latch 16 can be released from slot 26, allowing cover 2 to open.

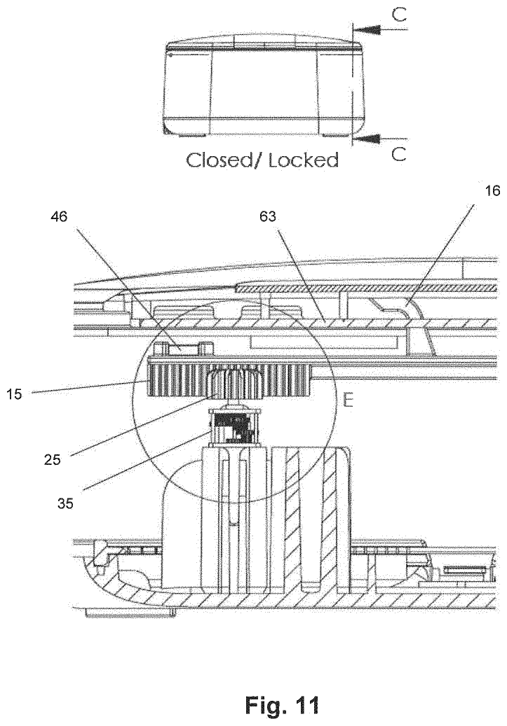

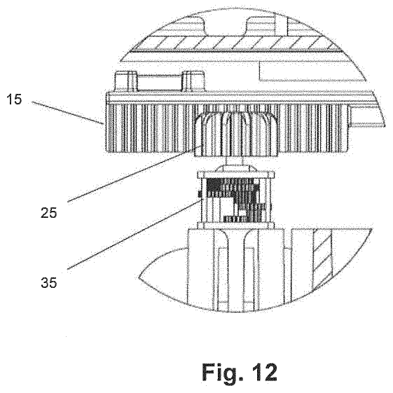

FIGS. 11 and 12 depict details of the system employed to move lock carriage 63 between locked and unlocked positions, including rack 15, pinion 25 and driving gears 35, provided to rotate the pinion, driven by a remotely controlled motor (not shown).

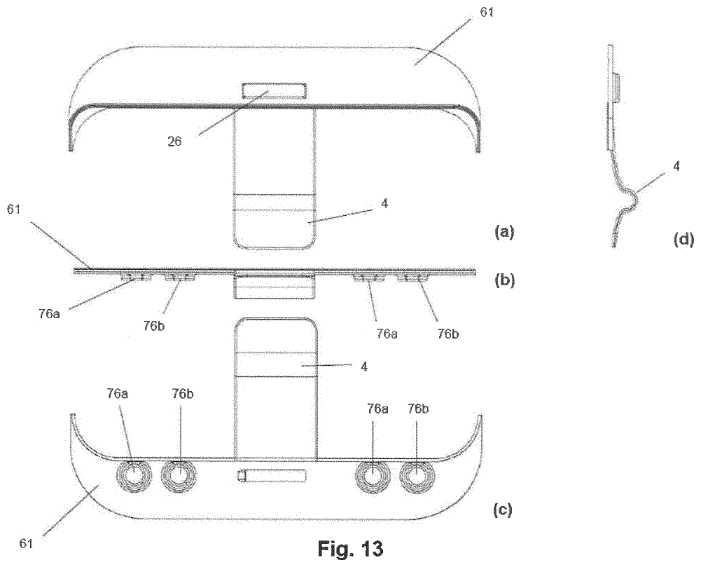

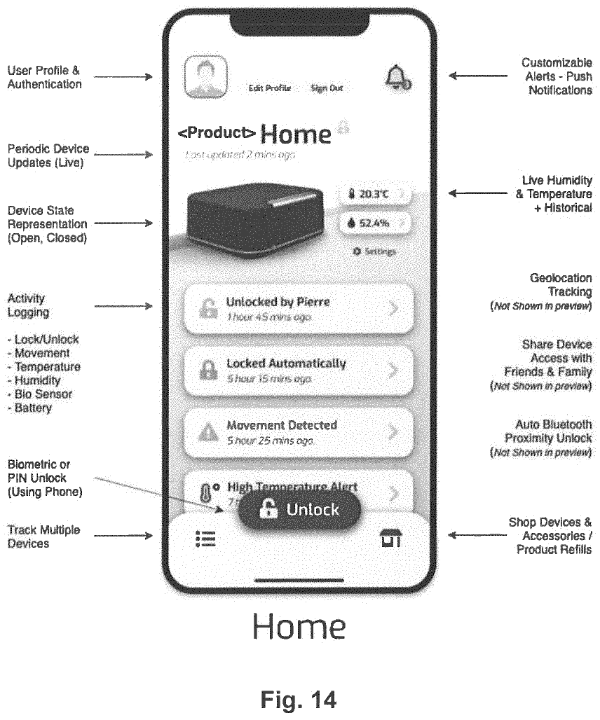

Lock plate 61, associated with cover member 2 in one embodiment of the invention, is shown in isolation in FIGS. 13A-D, which clearly show magnet wells 76a and 76b, as well as humidity management module holder 4.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A system for secure storage and management of a stored product, the system comprising:
a storage module comprising:
a body member having a bottom and side walls forming an interior volume;
a cover member moveable between an open position and a closed position, the cover member being adapted for sealing engagement with the body member when in the closed position to provide a sealed interior volume;
one or more compartments located within the interior volume of the body member, wherein at least one of the compartments is a storage compartment for storing the product; and
a locking system for locking the cover member in the closed position; and a management module, the management module comprising:
one or more sensors for obtaining information regarding one or more states of the system;
a remote terminal configured to display the information regarding one or more states of the system; and
a network interface component coupling the system to a wireless network configured to transmit the information to a receiver associated with the remote terminal, wherein the information is displayed on a user interface on the remote terminal.

2. The storage system of claim 1, wherein the management module further comprises a non-transitory memory and one or more hardware processors coupled to the non-transitory memory and configured to read instructions from the non-transitory memory to cause the system to perform operations comprising:
obtaining the information regarding one or more states of the system;
determining whether the obtained values regarding the one or more states of the system fall within a predetermined range of values; and
if the obtained values do not fall within the predetermined range of values, issuing an alert to be displayed on the remote terminal.

3. The storage system of claim 1, wherein the network interface component is an infrared apparatus, a Bluetooth apparatus, a WIFI apparatus or an Internet apparatus, and the remote terminal is an apparatus matching the network interface component and is capable of infrared communication, Bluetooth communication, or accessing the network via WIFI or the Internet

4. The storage system of claim 1, wherein the remote terminal is a smartphone, a tablet, a laptop, a personal computer, or a wall mounted graphical interface, and the management module is monitored via a mobile application associated with the remote terminal.

5. The storage system of claim 4, wherein the management module is configured to issued alert notifications when one or more states of the storage system as measured by the one or more sensors fall outside predefined parameters, wherein the alert notification is reported to and displayed on the user interface of the mobile application.

6. The storage system of claim 5, wherein the one or more sensors includes one or more of a humidity sensor associated with the storage compartment for measuring a relative humidity level in the storage compartment, a weight sensor for measuring a weight of the product in the storage compartment, and a temperature sensor associated with the storage compartment for measuring a temperature in the storage compartment.

7. (canceled)

8. (canceled)

9. The storage system of claim 5, wherein the one or more sensors further include a sensor associated with the locking system, wherein the locking system sensor measures the number of times the storage module is opened and/or the number of attempts to open the storage module.

10. The storage system of claim 1, wherein the locking system is a combination lock, a passcode activated lock, a voice activated lock, a biometric verification activated lock, a USB key activated lock, or any combination thereof.

11. The storage system of claim 1, wherein the locking system can be activated remotely using a command sent via the wireless network connection.

12. The storage system of claim 1, wherein the locking system can be engaged or disengaged remotely using command instructions entered by the user via a user interface on a mobile application associated with the remote terminal.

13. The storage system of claim 1, wherein the system further comprises a humidity management module for controlling the relative humidity in the storage compartment.

14. The storage system of claim 13, wherein the humidity management module comprises a replaceable or renewable humectant/dessicant system.

15. The storage system of claim 13, wherein the humidity management module comprises a humidity element such as VaporBeads® or Boveda® packs

16. The storage system of claim 1, wherein the storage module is manufactured from an opaque material.

17. The storage system of claim 1, wherein the storage module is manufactured from molded plastic, steel, aluminum or any combination thereof.

18. The storage system of claim 1, wherein the system further comprises a sealing element between the cover member and the body member.

19. The storage system of claim 1, wherein the storage module further comprises an external humidity display to display the relative humidity level in the storage compartment.

20. The storage system of claim 1, wherein the storage module further comprises an external indicator that is an LED light configured to provide an indication when the storage module is in a locked or unlocked state.

21. (canceled)

22. The storage system of claim 1, wherein the system further comprises a motion sensor configured to detect when the system is moved and/or a location tracker.

23. The storage system of claim 22, wherein the motion sensor comprises an accelerometer.

24. The storage system of claim 1, wherein the remote terminal is configured to issue an alert when the system is disconnected from the wireless network and/or a power source.
